(19) United States
(12) Patent Application Publication
(10) Pub. No.: US 2014/0282295 A1
(43) Pub. Date: Sep. 18, 2014

(54) Method for Forming Photo-masks and OPC Method

(71) Applicant: UNITED MICROELECTRONICS CORP., Hsin-Chu City (TW)

(72) Inventors: Chun-Hsien Huang, Tainan City (TW); Ming-Jui Chen, Hsinchu City (TW); Ching-Chun Huang, Tai-Chung City (TW); Chia-Wei Huang, Kaohsiung City (TW); Yu-Feng Chao, Hsinchu City (TW); Yu-Chuan Chang, Tainan City (TW)

(73) Assignee: UNITED MICROELECTRONICS CORP., Hsin-Chu City (TW)

(21) Appl. No.: 13/802,833

(22) Filed: Mar. 14, 2013

(51) Int. Cl. G06F 17/50

(52) U.S. Cl. CPC G06F 17/50
USPC 716/53

(57) ABSTRACT

The present invention provides a method for forming at least a photo mask. A first photo-mask pattern relating to a first structure is provides. A second photo-mask pattern relating to a second structure is provides. A third photo-mask pattern relating to a third structure is provides. The first structure, the second structure and the third structure are disposed in a semiconductor structure in sequence. An optical proximity process including a comparison step is provided, wherein the comparison step includes comparing the first photo-mask pattern and the third photo-mask pattern. Last, the first photo-mask pattern is import to form a first mask, the second photo-mask pattern is import to form a second mask, and the third photo-mask pattern is import to form a third mask. The present invention further provides an OPC method.

### BACKGROUND OF THE INVENTION

1. Field of the Invention

The present invention relates to an OPC method and method using the OPC method for forming at least a photo-mask, and more particularly, the photo-masks are used in a dual-damascene manufacturing process.

2. Description of the Prior Art

In semiconductor manufacturing processes, in order to transfer an integrated circuit layout onto a semiconductor wafer, the integrated circuit layout is first designed and formed as a photo-mask pattern. The photo-mask pattern is then proportionally transferred to a photoresist layer positioned on the semiconductor wafer.

In recent years, with the increasing miniaturization of semiconductor devices, the design rule of line width and space between lines or devices becomes finer. However, the width is subject to optical characteristics. To obtain fine-sized devices in the exposure, the interval between transparent regions in a mask is scaled down with device size. When the light passes through the mask, diffraction occurs and reduces resolution. Moreover, when light passes through the transparent regions of a mask having different interval sizes, the light through the regions having small interval sizes is influenced by the transparent regions having large interval sizes and results in deformation of the transfer pattern. Currently, a technical called “optical proximity correction (OPC)” is developed. The OPC method is to imitate the feature that light passes through the photo-mask and to further compensate the pattern of the mask to form the desired pattern after the exposure process.

In the conventional arts, the “dual damascene” process is wildly used to form a metal interconnection system which is consisted of metal lines and plugs. However, the OPC method used for forming the masks of the metal interconnection system is not well studied.

### SUMMARY OF THE INVENTION

The present invention therefore provides a method for forming at least a photo-mask, which is used in a dual-damascene process.

According to one embodiment, the present invention provides a method for forming at least a photo mask. A first photo-mask pattern relating to a first structure is provides. A second photo-mask pattern relating to a second structure is provides. A third photo-mask pattern relating to a third structure is provides. The first structure, the second structure and the third structure are disposed in a semiconductor structure in sequence. An optical proximity process including a comparison step is provided, wherein the comparison step includes comparing the first photo-mask pattern and the third photo-mask pattern. Last, the first photo-mask pattern is import to form a first mask, the second photo-mask pattern is import to form a second mask, and the third photo-mask pattern is import to form a third mask.

According to another embodiment, the present invention further provides an OPC method. A first photo-mask pattern relating to a first structure is provides. A second photo-mask pattern relating to a second structure is provides. A third photo-mask pattern relating to a third structure is provides. The first structure, the second structure and the third structure are disposed in a semiconductor structure in sequence. A comparison step is provided, wherein the comparison step includes comparing the first photo-mask pattern and the third photo-mask pattern. Last, the first photo-mask pattern is import to form a first mask, the second photo-mask pattern is import to form a second mask, and the third photo-mask pattern is import to form a third mask.

The photo-mask formed by the present invention is specially used in the dual-damascene process. It is one salient feature that the photo-mask patterns which are separated by another photo-mask pattern are compared, so the short phenomenon in conventional dual damascene structure can be avoided.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic diagram of the top view of the semiconductor structure in the present invention.

FIG. 2 to FIG. 6 show cross sectional schematic diagrams of the method for forming photo-masks in the present invention.

FIG. 7 shows a schematic diagram of the overlapped first photo-mask pattern, the second photo-mask pattern and the third photo-mask pattern.

FIG. 8 shows a schematic diagram of the flow chart in the present invention.

FIG. 9 and FIG. 10 show schematic diagrams of the comparing step and the correction step in the present invention.

### DETAILED DESCRIPTION

To provide a better understanding of the presented invention, preferred embodiments will be made in detail. The preferred embodiments of the present invention are illustrated in the accompanying drawings with numbered elements.

The present invention is related to a method for forming photo-masks which is used in a semiconductor process to form a semiconductor structure. In one embodiment, the semiconductor process is a metal dual damascene process, and the semiconductor structure is a metal interconnection system, but is not limited thereto. Please refer to FIG. 1, which shows a schematic diagram of the top view of the semiconductor structure in the present invention. From the top view of FIG. 1, the semiconductor structure to be formed in the present invention includes a first plug 310, a first metal line 312, a second plug 318, which are disposed in different dielectric layers, and are disposed from up to bottom in sequence. It is noted that the numbering only shows the relative position but does not indicate the real stacking position on the substrate.

About the three-dimensional relationship and the forming method of the first plug 310, the first metal layer 312, and the second plug 318, please refer to FIG. 2 to FIG. 6, which show cross-sectional schematic diagrams of the method for forming photo-masks in the present invention, wherein FIG. 2 to FIG. 6 are illustrated according to line AA′ in FIG. 1. As shown in FIG. 2, a substrate 300 is provided. The substrate 300 may be a silicon substrate or a dielectric layer on the silicon substrate, but is not limited thereto. A dielectric layer 302 and a dielectric layer 304 are disposed on the substrate 300. The dielectric layer 302 and the dielectric layer 304 can be a lower and upper part of a single dielectric layer. A photo-etching-process (PEP) is performed by using a first mask (not shown) to form a trench 306 in the dielectric layer 304, wherein the trench 306 has a width W1.

As shown in FIG. 3, another PEP process is carried out by using a second photo-mask (not shown) to form a hole 308 in the dielectric layer 304 and the dielectric layer 302. The hole 308 overlaps the trench 306 and has a width W2. The width W1 and W2 can be adjusted according to the design of devices, and in one embodiment, the width W2 is greater than the width W1.

As shown in FIG. 4, a metal layer is filled in to the trench 306 and the hole 308. The metal layer in the trench 306 becomes the first metal layer 312 as in FIG. 1, and the metal layer in the hole 308 becomes the first plug 310 as in FIG. 1. For clear description, the metal layer is shown as two layers, such as the first metal layer 312 and the first via 310, however, to one of ordinary skills in the art, the metal layer can be of one single layer.

As shown in FIG. 5, after repeating the steps of FIG. 2 and FIG. 4, a second plug 318 and a second metal line 320 are formed in a dielectric layer 314 and a dielectric layer 316, which are above the dielectric layer 304. The second plug 318 is disposed over the first plug 310 and a horizontal gap G1 lies therebetween. In general, the gap G1 is above a determined value, but in some circumstances, for example, in some manufacturing defects, or under some OPC rules, the gap G1 will be disappeared, resulting in a short phenomenon between the first plug 310 and the second plug 318.

Please refer to FIG. 7, which shows a schematic diagram of the overlapped first photo-mask pattern 400, the second photo-mask pattern 402 and the third photo-mask pattern 404, in which the first photo-mask pattern 400 is used formed the first plug 310 as in FIG. 1, the second photo-mask pattern 402 is used to form the first metal layer 312, and the third photo-mask pattern 404 is used to form a second plug 318. It is one salient feature in the present invention that, not only the relationship between the first photo-mask pattern 400 and the second photo-mask pattern 402, the relationship of the second mask pattern 402 and the third photo-mask pattern 404 are considered, but the relationship between the first photo-mask pattern 400 and the third photo-mask pattern 404 is considered. A between the first plug 310 and the second plug 318 is checked so as to avoid the short problem in FIG. 6. In other words, besides comparing two adjacent photo-mask pattern layers, the present invention further compares the layers of photo-mask pattern which are separated by one photo-mask layer. In one embodiment, these “two next” photo-mask patterns (the first photo-mask layer 400 and the third photo-mask layer 404 for example) are related to the plugs. That is, in the comparing step, the n^{th} layer plug (plug n) and n+1^{th} plug (plug n+1) are compared to check if their distance is so close to cause short and needed to be corrected.

Please refer to FIG. 8, which shows a schematic diagram of the flow chart in the present invention. As shown in FIG. 8, the method for forming at least a photo-mask includes providing a first photo-mask pattern, a second photo-mask pattern and a third photo-mask pattern in a computer storage system (step 502). The first photo-mask pattern is related to a first structure. The second photo-mask pattern is related to a second structure. The third photo-mask pattern is related to a third structure. The first structure, the second structure and the third structure are disposed in a semiconductor structure in sequence. Taking FIG. 7 for example, the first photo-mask pattern 400 is used to form the first plug 310, the second photo-mask pattern 402 is used to form the first metal layer 312, and the third photo-mask pattern 404 is used to form the second plug 318. The first plug 310, the first metal layer 312, and the second plug 318 are disposed in sequence, as in FIG. 5.

Next, an OPC step is carried out by using the computer system. The OPC step, for example, includes considering the shape, the area or the position of the first plug 310 of the first photo-mask pattern 400, or considering the shape, the area or the position of the first metal layer 312 of the second photo-mask pattern 402, or considering the shape, the area or the position of the second plug 318 of the third photo-mask pattern 404 to see if a corresponding correction is required. Next, the OPC step includes considering the relationship between the first photo-mask pattern 400 and the second photo-mask pattern 402, the relationship between the second photo-mask pattern 402 and the second photo-mask pattern 404 to see a corresponding correction is required. Most importantly, the OPC in the present invention further includes considering the “two next” photo-mask patterns. For example, the OPC method includes a comparing step that compares the first photo-mask pattern 400 and the third photo-mask pattern 404 (step 504). In one embodiment, the comparing step is to check if a predetermined distance is disposed between the first photo-mask pattern 400 and the third photo-mask pattern 404. Then, according the result of the comparing step, an optional correction step is further provided. The comparing step and the correction step will be described in the following context.

Last, the first photomask pattern is import to form a first mask, the second photomask pattern is import to form a second mask, and the third photomask pattern is import to form a third mask (step 506).

Please refer to FIG. 9 and FIG. 10, which show schematic diagrams of the comparing step and the correction step in the present invention. As shown in FIG. 9, a fourth plug photo-mask pattern 600, a fourth circuit photo-mask pattern 601, a fifth plug photo-mask pattern 602, a fifth circuit photo-mask pattern 603, a sixth plug photo-mask pattern 604 are overlapped. In one embodiment, the fourth plug photo-mask pattern 600 is used to form the 4th layer plug, including a 4th plug 600a. The fourth circuit photo-mask pattern 601 is used to form the 4th metal line (metal 4) on the 4th plug. The fifth plug photo-mask pattern 602 is used to form the 5th plugs, including 5th plug pattern 602a, 602b, 602c, which are disposed on metal 4. The fifth circuit photo-mask pattern is used to form the 5th metal layer (metal 5) on the 5th plug. The sixth plug photo-mask pattern 604 is used to form 6th plugs, including 6th plug patterns 604a, 604b, 604c, which are disposed on metal 5.

In the comparing step, the “two next” plug photo-mask patterns are compared (each “two next” plug photo-mask patterns are separated by one circuit photo-mask pattern). For example, the distance between the 4th plug pattern 400a and the 5th plug pattern 602c is less than a predetermined value D, so the correction step should be subsequently performed. In another example, the distance between the 5th plug pattern 602a and the 6th plug pattern 604c is less than a predetermined value D, so the correction step should be subsequently performed. In another example, the distance between the 5th plug pattern 602a and the 6th plug pattern 604c is greater than a predetermined value D, so the correction step is not required.

As shown in FIG. 10, according to the result of the comparing step, the distance of each plug pattern is enlarged. In one embodiment, the width of the 4th plug pattern and the width of the 5th plug pattern are decreased, for example, decreasing a width W′ from the 5th plug pattern to substantially enlarge the distance therebetween. In another embodiment, the length of the 4th plug pattern and the length of the 5th plug pattern are increased, for example, adding a length L′ to the 5th plug pattern, to maintain the depth of field (DOF) of each plug pattern and keep the conductive area above a fixed value. It is noted that the shape of the plug is not limited to be a rectangle but can be other shapes such as a circle. The width and the length are based on the distance line. If the distance line is defined as x-axis and the perpendicular direction is defined as y-line, the width refers to the value projected on the x-axis and the length refers to the value projected on the y-axis.

In summary, the photo-mask formed by the present invention is specially used in the dual-damascene process. It is one salient feature that the “two next” photo-mask patterns are considered so the short phenomenon in conventional dual damascene structure can be avoided. In addition, the steps in FIG. 2 to FIG. 5 show a “trench first” method, but it is understood that a “via first” method as well as other dual damascene can also be applied in the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for forming a photo-mask, comprising:
providing a first photo-mask pattern relating to a first structure, a second photo-mask pattern relating to a second structure, and a third photo-mask pattern relating to a third structure, wherein the first structure, the second structure and the third structure are disposed in sequence in a semiconductor structure;
performing an optical proximity correction (OPC) process, comprising a comparing step including comparing the first photo-mask pattern and the third photo-mask pattern; and
outputting the first photo-mask pattern to form a first mask, outputting the second photo-mask pattern to form a second mask, and outputting the third photo-mask pattern to form a third mask.

2. The method for forming a photo-mask as in claim 1, wherein the comparing step comprises checking if a distance between the first photo-mask pattern and the third photo-mask pattern is greater than a predetermined value.

3. The method for forming a photo-mask as in claim 2, wherein the OPC process comprises a correction step comprising correcting the first photo-mask pattern and the third photo-mask pattern based on the comparing step.

4. The method for forming a photo-mask as in claim 3, wherein the correction step comprises enlarging the distance between the first photo-mask pattern and the third photo-mask pattern.

5. The method for forming a photo-mask as in claim 3, wherein the correction step comprises decreasing a width of the first photo-mask pattern.

6. The method for forming a photo-mask as in claim 3, wherein the correction step comprises decreasing a width of the first photo-mask pattern and increasing a length of the first photo-mask pattern.

7. The method for forming a photo-mask as in claim 1, wherein the first photo-mask pattern is circular, the second photo-mask pattern is rectangular and the third photo-mask pattern is circular.

8. The method for forming a photo-mask as in claim 1, wherein the first structure is a plug, the second structure is a metal line and the third structure is another plug.

9. The method for forming a photo-mask as in claim 1, wherein the OPC process further comprises comparing the first photo-mask pattern and the second photo-mask pattern.

10. The method for forming a photo-mask as in claim 1, wherein the OPC process further comprises comparing the second photo-mask pattern and the third photo-mask pattern.

11. An optical proximity correction (OPC) method, comprising:
providing a first photo-mask pattern relating to a first structure, a second photo-mask pattern relating to a second structure, and a third photo-mask pattern relating to a third structure, wherein the first structure, the second structure and the third structure are disposed in a semiconductor structure in sequence;
performing a comparing step including comparing the first photo-mask pattern and the third photo-mask pattern; and
outputting the first photo-mask pattern to form a first mask, outputting the second photo-mask pattern to form a second mask, and outputting the third photo-mask pattern to form a third mask.

12. The OPC method as in claim 11, wherein the comparing step comprises checking if a distance between the first photo-mask pattern and the third photo-mask pattern is greater than a predetermined value.

13. The OPC method as in claim 12, further comprising a correction step comprising correcting the first photo-mask pattern and the third photo-mask pattern based on the comparing step.

14. The OPC method as in claim 13, wherein the correction step comprises enlarging the distance between the first photo-mask pattern and the third photo-mask pattern.

15. The OPC method as in claim 13, wherein the correction step comprises decreasing a width of the first photo-mask pattern.

16. The OPC method as in claim 13, wherein the correction step comprises decreasing a width of the first photo-mask pattern and increasing a length of the first photo-mask pattern.

17. The OPC method as in claim 11, wherein the first photo-mask pattern is circular, the second photo-mask pattern is rectangular and the third photo-mask pattern is circular.

18. The OPC method in claim 11, wherein the first structure is a plug, the second structure is a metal line and the third structure is another plug.

19. The OPC method as in claim 11, further comprising comparing the first photo-mask pattern and the second photo-mask pattern.

20. The OPC method as in claim 11, further comprising comparing the second photo-mask pattern and the third photo-mask pattern.
